(19) United States
(12) Patent Application Publication
(10) Pub. No.: US 2025/0279679 A1
(43) Pub. Date: Sep. 4, 2025

(54) POOL ASSOCIATED PLATFORMS AND POOL CLEANING ROBOTS AND ACTIVE RECEIVER FOR ENHANCED DETECTION IN WIRELESS POWER TRANSFER SYSTEMS

(71) Applicant: Maytronics Ltd., Kibbutz Yizrael (IL)

(72) Inventor: Netanel SPEKTOR, Kibbutz Meirav (IL)

(73) Assignee: Maytronics Ltd., Kibbutz Yizrael (IL)

(21) Appl. No.: 18/593,916

(22) Filed: Mar. 3, 2024

(51) Int. Cl. H02J 50/90; E04H 4/16; H02J 50/12

(52) U.S. Cl. CPC H02J 50/90; E04H 4/1654; H02J 50/12

(57) ABSTRACT

A wireless charging system for a poolside platform utilizes magnetic fields transmitted from edge stations to a receiving unit on the platform. The receiving unit actively adjusts its response to maintain a connection despite varying positions and wet environments, enabling efficient and automated wireless charging.

### FIELD AND BACKGROUND OF THE INVENTION

The present invention, in some embodiments thereof, relates to Wireless Power Transfer Systems for wireless charging of pool associated platforms and, more particularly, but not exclusively, to a receiver for enhanced detection in wireless power transfer systems of wireless charging of pool associated platforms.

Examples for such platforms are platforms with Buoys, floating skimmers, pool (cleaning robots), chlorinators, filters, pumps, and skimmers. For example, see intentional patent number WO2023223187A1 that teaches a pool related platform that may include one or more power consuming elements; and a wireless power transfer interface module that comprises a ferromagnetic element that is located within a housing, the housing comprises a first housing part and a second housing part, the second housing part is secured to the first housing part

Wireless power transfer systems have been used to provide power to such platforms without physical, wired connections. Magnetic induction or magnetic resonance are typically used to transfer power over the air between a transmitting coil and receiving coil.

In some platforms, the power transmitter will check for the presence of a receiver before delivering higher levels of wireless power. This is typically done using “analog pings”, where the transmitter coil current is measured as the transmitting coil oscillator is turned on and off. The rate of amplitude decay when the oscillator is off provides information on whether a resonant receiving coil is present in proximity.

### SUMMARY OF THE INVENTION

According to some embodiments of the present invention there is provided a wireless power transfer system for wirelessly charging a poll associated platform, comprising:
a wireless charging station comprising: a power transmitting unit (TX) configured to transmit wireless power by oscillating a TX coil current and detecting a power receiving unit (RX) by analyzing decay characteristics of the TX coil current;
wherein the poll associated platform having a water sealed compartment comprising a battery electrically connected to a power receiving unit (RX) comprising an RX coil;
wherein the power receiving unit (RX) further comprises a decay frequency circuit operatively coupled to the RX coil, said decay frequency circuit is configured to:
(a) detect when the power transmitting unit (TX) transmits wireless power in proximity to the power receiving unit (RX),
(b) actively oscillate the RX coil at a frequency matching the TX coil frequency, in response to said detection,
thereby influencing the decay characteristics of the TX coil current to enable more reliable detection by the power transmitting unit (TX) that the RX unit is present on or near the wireless charging station.

Optionally, further comprising a proximity detector circuit to detect when the power transmitting unit (TX) transmits wireless power in proximity by detecting a marker signal transmitted by the TX.

Optionally, further comprising a proximity detector to detect when the power transmitting unit (TX) transmits wireless power in proximity by detecting an increase in voltage, current, or power induced in the RX coil.

Optionally, wherein the decay frequency matching between the TX coil and RX coil is achieved by making active decay to the RX coil.

Optionally, wherein the frequency matching between the TX coil and RX coil is achieved by tuning the variable oscillator frequency in the active oscillation circuitry to match the sensed TX coil decay frequency.

Optionally, wherein influencing the decay characteristics of the TX coil current enables detection by amplitude drop thresholds over time.

Optionally, wherein influencing the decay characteristics of the TX coil current enables more consistent decay signature profiles analyzed by the power transmitting unit to detect the presence of the RX coil in proximity.

According to some embodiments of the present invention there is provided a method for wireless power transfer to a poll associated platform comprising: within a power transmitting unit (TX) of the poll associated platform charging station:
(a) transmitting wireless power by oscillating a current in a TX coil;
(b) detecting presence of a power receiving unit (RX) by analyzing decay characteristics of the TX coil current when oscillation is paused;
within a power receiving unit (RX) containing an RX coil in a water sealed compartment of the poll associated platform:
(c) detecting when wireless power signals are transmitted in proximity of the RX unit;
(d) actively oscillating the RX coil at a decay frequency in response to detection of the proximate wireless power signals;
   whereby actively oscillating the RX coil influences the decay characteristics of the TX coil current, enabling more reliable detection by the TX unit that the RX unit is present near a wireless charging station based on the altered decay characteristics.

According to some embodiments of the present invention there is provided a method for enabling enhanced detection in a wireless power receiving unit (RX) containing an RX coil, the method comprising:
(a) at a wireless charging station, detecting, by a proximity detector circuit, when wireless power transmission signals from a power transmitting unit (TX) of the wireless charging station are present in proximity of the RX coil;
(b) in a water sealed compartment of a poll associated platform, in response to said detection of proximate TX signals, activating an oscillation circuit operatively coupled to the RX coil in the water sealed compartment;
(c) actively oscillating the RX coil utilizing the activated oscillation circuit, at a frequency matched to a frequency of a TX coil in the transmitting unit;
wherein actively oscillating the RX coil is timed to influence decay characteristics of a current in the TX coil, thereby enabling more reliable detection by the TX that the RX is present near the wireless charging station due to distinct patterns caused in the TX coil current decay shape.

Optionally, wherein the RX coil is located within a distance of less than 10 millimeter from the TX coil.

Optionally, wherein the frequency matching between the TX coil and the RX coil is achieved by tuning an RX oscillation circuit capacitance to make the RX coil resonant at the same frequency as the TX coil frequency.

Optionally, wherein actively oscillating the RX coil utilizes a frequency decay circuit in order to tune an oscillation frequency generated in the RX to match a frequency of detected TX wireless power transmission signals.

Optionally, wherein influencing decay characteristics of the TX coil current enables detection by amplitude drop thresholds over time in the TX circuit.

Optionally, wherein influencing decay characteristics of the TX coil current induces repeatable perturbation patterns that are analyzed in the TX to reliably detect presence of the RX.

According to some embodiments of the present invention there is provided a wireless power receiving apparatus comprising:
an RX coil configured to receive wireless power signals;
a proximity detector circuit operatively connected to the RX coil configured to detect when wireless power transmission signals from a power transmitting unit (TX) are present in proximity of the RX coil;
a frequency decay circuit operatively connected to RX coil, said frequency decay circuit configured to: (a) activate in response to detection of proximate TX signals by the proximity detector circuit, (b) actively oscillate the RX coil at a frequency matched to a TX coil frequency in the TX;
   wherein activation and active oscillation of the frequency decay circuit is configured to influence decay characteristics of a TX coil current in the TX, thereby enabling more reliable detection by the TX that the wireless power receiving apparatus is present near a wireless charging station due to distinct patterns caused in the TX coil current decay shape.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an exemplary schematic illustration of a pool cleaning system having a docking station with a power transmitting unit configured to charge a battery of an automated pool cleaning robot having a power receiving unit;

FIG. 2 is a schematic illustration of a wireless power transfer system comprising a power transmitting unit configured to transfer power to a power receiving unit;

FIG. 3 is a method for wireless power transfer that uses for example the wireless power transfer system, according to some embodiments of the present invention;

FIGS. 4A and 4B images depict decay characteristics of a signal read by a rectification/regulation circuit when a frequency decay circuit is not activated and when the frequency decay circuit is activated, according to some embodiments of the present invention; and

FIG. 5 is a schematic illustration of a method of enabling enhanced detection in a wireless power receiving unit containing a coil, according to some embodiments of the present invention.

### DESCRIPTION OF SPECIFIC EMBODIMENTS OF THE INVENTION

The present invention, in some embodiments thereof, relates to Wireless Power Transfer Systems and, more particularly, but not exclusively, to a receiver for enhanced detection in wireless power transfer systems.

As indicated above, in some systems, the power transmitter will check for the presence of a receiver before delivering higher levels of wireless power. This is typically done using “analog pings”, where the transmitter coil current is measured as the transmitting coil oscillator is turned on and off. The rate of amplitude decay when the oscillator is off provides information on whether a receiving coil is present in proximity.

Challenges can arise in accurately detecting receiving devices due to interference, alignment issues, weak or distorted communication signals, or noisy power transfer environments. This can result in false positive or false negative detections during the analog ping processes.

Prior art systems have focused on improved signal processing and detection algorithms on the transmitter side to try to overcome these issues. However, there are still significant limitations, for example when trying to detect very small internet-of-things (IoT) devices with compact receive coils.

Therefore, there is a need for improved techniques to enable more robust and reliable detection in wireless power transfer systems. More responsive and adaptive mechanisms are needed, particularly as transmitters must be compatible with a wide array of receiving devices.

The present disclosure relates to systems and methods for improved detection capabilities in wireless power transfer between a transmitting unit and receiving unit.

A wireless power transmitting unit (TX) is configured to oscillate a transmitter coil to wirelessly transfer power based on magnetic fields. The TX detects presence of a receiver (RX) by analyzing current decay characteristics in the transmit coil when briefly pausing the oscillations. This “analog pinging” has reliability challenges.

Some embodiments of the present invention improve detection reliability by having the power receiving unit play an active role. The RX contains a proximity detector to identify when a transmitting signal is nearby. In response, an oscillation circuit actively drives the receiving coil to resonate at the transmit frequency.

This wireless power receiver architecture with reactive oscillation capability enables intentionally influencing the current decay shape in the transmit coil when its oscillations are paused. Distinct patterns caused by the interacting resonant coils allows the TX to robustly detect that a receiving unit is present near the charging station.

In this manner, a smart reactive receiver facilitates more accurate ping decoding and decision making at the transmitter to reliably activate wireless charging connections and transmission handshaking. This enhances overall coordination and performance in wireless power systems.

As will be described herein, the wireless power transfer system containing power transmitting units and power receiving units with actively oscillating receiver coils provides particular benefit for contactless charging of automated pool cleaning robots. Pool environments pose challenges to consistent power delivery due to wet conditions and variability in relative coil positioning as the mobile robot navigates waterline surfaces. By integrating the described power receiving circuitry and receiver coil into pool robots, intelligent reactive participation enables reliable detection by transmitter base stations which is located for example along the pool edge or near the pool. Active oscillations from robot receiver(s), induce distinct current decay signatures perceivable despite fluctuations in coil alignments or water interference.

Responsive identification signaling between active receiver units in a pool robot and a stationary edge transmit charging station allows consistent activation of wireless charging fields as a robot roams into proximity. The ability for mobile receiving coils to dynamically influence static transmitting coils provides flexible freedom for coupling versus strict placement precision requirements. This intelligent power transfer targeting and efficiency allows rapid automated recharging whenever a pool cleaner robot is placed in operational proximity to a wireless charging station. Contactless charging ensures charging of the battery of the robot for continuous operation to completion of full pool surface coverage. By enabling dynamic wireless power handshaking resilience between mobile wet receivers and static transmitters, reliable charging facilitates extensive automated pool scrubbing duration.

According to some embodiments of the present invention there is provided an improved detection approach in wireless power transfer systems between a transmitter and receiver is provided through intelligent and reactive receiving units. A power transmitting unit (TX) oscillates a transmit coil to transfer wireless energy based on magnetic resonance principles and pauses oscillations briefly to analyze current decay shapes to detect nearby receivers. Power receiving units (RXs) in the system contain a proximity detector to identify when TX signals are nearby and, in response, activate a frequency decay circuit such as an oscillation circuit to drive the receiver coil to resonate at the transmit frequency. By specifically timing receiver oscillation periods to influence current decay characteristics in the transmit coil, the RX can intentionally create distinct detection patterns when the TX pauses oscillations. Analyzing the modified pattern, phase, level change speed, or harmonic elements in the perturbed decay waveform allows the TX circuitry to much more reliably detect the presence of receiving units near the wireless charging station. Actively manipulating transmit coil current shapes by timed reactive receiving unit oscillation enables robust, resilient and flexible detection capabilities improving overall coordination in wireless power systems.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

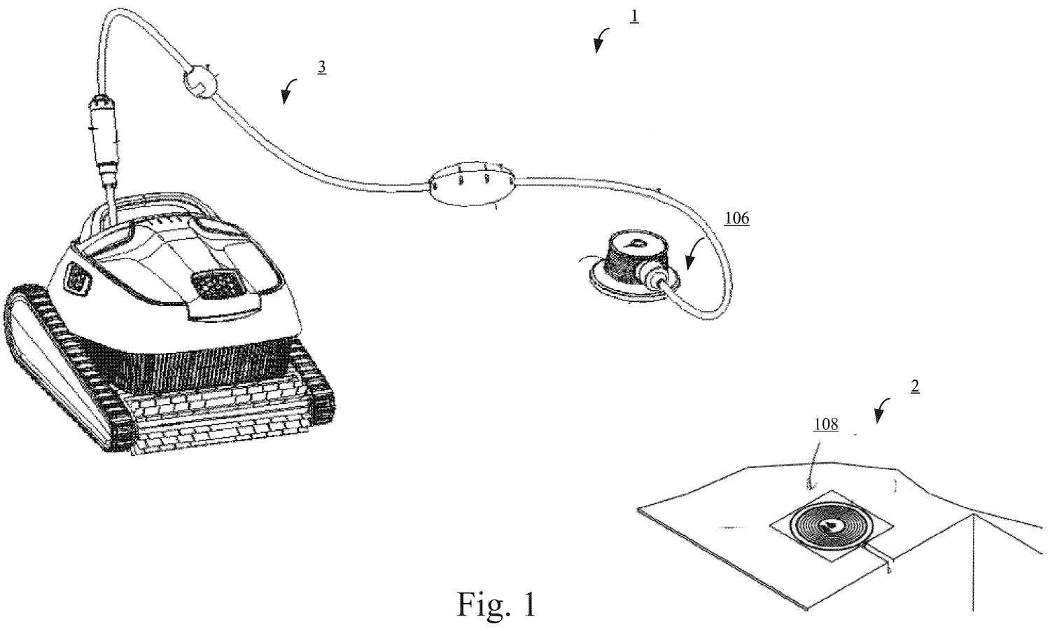

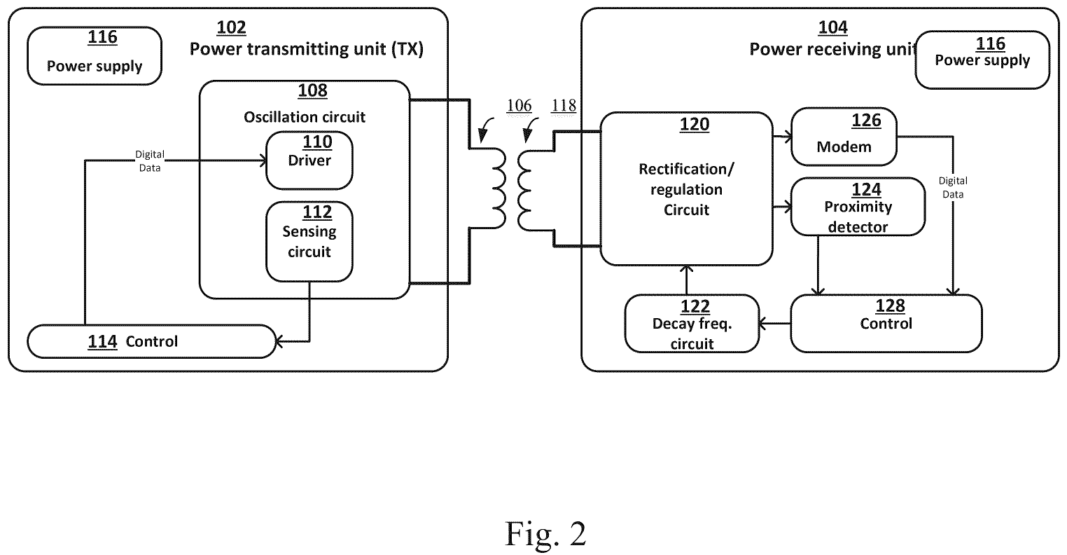

Reference is now made to FIG. 1 is an exemplary schematic illustration of a pool cleaning system (1) having a docking station (2) with a power transmitting unit (e.g. 102 in FIG. 2) configured to charge a battery of an automated pool cleaning robot (3) having a power receiving unit (e.g. 104 in FIG. 2) and to FIG. 2 which is a schematic illustration of a wireless power transfer system 100 comprising a power transmitting unit 102 (also referred to as a transmitter or TX) configured to transfer power to a power receiving unit 104 (also referred to as a receiver or RX).

The power transmitting unit 102, also referred to as TX, includes a transmitter coil 106, oscillator circuit 108, driver 110, sensing circuit 112, control circuit 114, and power supply 116. The oscillator circuit 108 maybe an astable multivibrator circuit generating a 80 kHz square wave to drive the transmitter coil. Waveform graph of created oscillation signal. Components could include NE555 timer chip, resistors, and capacitors. The oscillation circuit 108 can generate signals of a desired transmission frequency which are amplified through driver 110 to drive transmitter coil current in the transmitter coil 106 to emit an electromagnetic field for power transfer.

The power receiving unit 104, also referred to as RX, includes a receiver coil 118 which has a frequency matched to the transmitting unit for receiving the electromagnetic flux, along with a rectification/regulation circuit 120 and a modem 126 to convert the received power to DC levels for use by the receiving device. In some embodiments of the present invention, the power receiving unit 104 contains a decay frequency circuit 122, a proximity detector 124, a modem 126 and a control 128.

Example of the coil 106 or coil 118 may be a planar coil made of insulated copper litz wire wrapped around a ferrite core, for instance with about 10 turns, 25 μH inductance, 0.2 ω DC resistance, frequency 80 kHz.

The with proximity detector 124 maybe a comparator circuit measuring received voltage from a small antenna coil, compared to a threshold to detect sudden increase indicating transmitting signals are close by. Plot of spiking receive coil voltage as transmitter nears. Optionally, in operation, proximity detection triggers the control 128, for instance a microcontroller, to operate the decay frequency circuit 122 to begin sweeping control voltage while monitoring received voltage levels to lock to an incoming transmit frequency. The signal drives the receiver coil to resonate, which influences the transmitter to improve detection. It should be noted that as used herein a circuit maybe a part of a circuit or multiple circuits which are electronically connected to one another.

According to some embodiments of the present invention the power transfer system 100 is embedded in a pool cleaning system where the power transmitting unit 102 is in a docking station configured to charge a battery of a water sealed compartment of an automated pool cleaning robot having the power receiving unit 104, for example in the water sealed compartment. The automated pool cleaning robot contains the described wireless power receiving unit (RX) allowing it to recharge its internal battery in the water sealed compartment without wired connections. The RX, including proximity detector, decay frequency circuit, and receiver coil, may be built into the chassis of the cleaning robot, situated close to the bottom exterior facing surface.

Optionally, around the perimeter of a swimming pool, one or more wireless power transmitting units (TX) such as 102 are embedded in weatherproof housings bolted to the pool deck. These pool edge TX stations contain the resonant transmit coil to output wireless energy focused in the pool just below each station. Alternatively the TX unit 102 is embedded in a station which is connected to an AC socket and place in any place that is convenient for the owner.

In use, optionally as the pool cleaning robot navigates along the waterline, its RX coil passes (or placed) near a TX station. The RX proximity detector senses the energy and activates the receiving side oscillator to resonate with the TX field. This strongly influences the local transmit coil's current decay pattern. Sensitive transmit detection circuitry analyzes the waveform signature to verify the robot RX is near the charging zone. Once confirmed, the TX stations focus additional power output to that area engage the robot RX more strongly to guide it to dock securely over that charging station. The active RX participation enables extremely reliable detection and charging trigger events despite wet environments and small fluctuating coil alignments. This flexible intelligent reactivity allows efficient automated recharging to extend cleaning runtime.

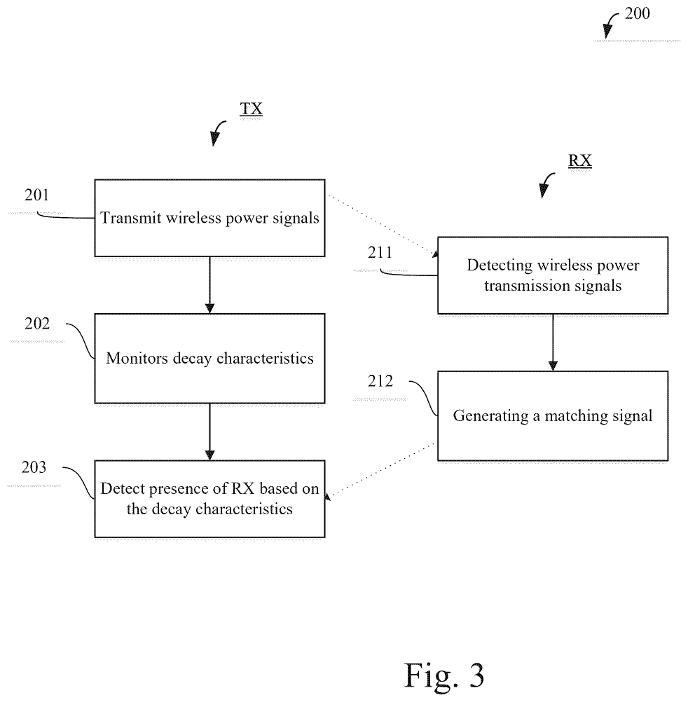

Reference is now also made to FIG. 3, which is a method 200 for wireless power transfer that uses for example the wireless power transfer system 100, according to some embodiments of the present invention. The method 200 is disclosed for enabling more reliable wireless power transfer between a transmitting unit (such as TX 102) and a receiving unit (such as RX 104) utilizing magnetic coupling between coils. The method involves steps within the TX 102 and RX 104. The method allows wirelessly charging a battery electrically connected to the RX, for instance in a water sealed compartment of a pool cleaning robot located near a charging station that includes the TX 102, optionally also in a water sealed compartment.

As shown at 201, in the TX 102, oscillator circuit 108 is activated to transmit wireless power signals by oscillating the TX coil 106 at a set frequency. The TX 102 maybe in a charging station of a pool cleaning robot as described above.

When the transmitter control circuit 114 turns off the oscillator driving the TX coil 106, the current through and voltage across the transmitter coil 106 starts decaying at a defined rate and exponential curve based on the coupled impedance. Without a receiver present, this decay would have exhibited a sharper drop-off profile that when the receiver is present as will be described below.

As shown at 202, transmitter sensing circuit 112 now monitors decay characteristics of TX coil current via sensing circuit 112 when oscillator 108 is paused 215.

As shown at 203, decay pattern data is analyzed via the control circuit 114 to detect presence of a receiving unit (RX) 104 based on the decay characteristics.

Optionally, the system is a wirelessly rechargable device, such as electronically connected battery of a pool clearing robot and the assumption is that a signal amplitude is higher when the TX is close to the Rx device and if the signal amplitude is lower it means that the TX (e.g. a Charger) the charger is not on a charging position of the wirelessly rechargable device, for instance the pool cleaner.

In the RX 104:

As shown at 211, a proximate wireless power transmission signals emanating from the TX 102 are detected using the proximity detector circuit 124 which is connected to the RX coil 118. The RX maybe hosted in a water sealed compartment of the wirelessly rechargable device, for instance of the pool clearing robot

[symbol]

In response to the proximate signal detection, as shown at 212, this triggers an activation of the decay frequency circuit 122+128, actively oscillating the RX coil 118 at a frequency matching the TX coil frequency utilizing the activated decay frequency circuit 122+128.

By activating oscillation of the RX coil 118 in coordination with periods when TX oscillator 108 is paused 215, decay characteristics 212 monitored by TX sensing circuit 112 exhibit distinct patterns 217 indicating RX presence to the TX control circuit 114. This allows start charging a battery electronically connected to the RX 104, for instance in the water sealed compartment.

In essence, the power receiving unit 104 generates a “reverse analog ping” signal back to the transmitter enabling more robust presence detection than traditional decay curve analysis alone. The cooperative tight coupling communication bolsters reliability.

Reference is now made to an exemplary description of the receiver operation.

As described above with reference to 211, in order to avoid contentious or even intermittent operation of the active decay frequency circuit 122, an operation that requires energy from a device hosting the power receiving unit 104 which is usually battery operated, the proximity detector 124 contains circuitry and components configured to detect indicators that a transmitting signal from a compatible wireless power transmitter is close by. This allows operating the decay frequency circuit 122 only when the power transmitting unit 102 is in a charging position, allows avoiding wasting stored energy as the tight, reactive detection coordination minimizes time needed at peak power draws, facilitating faster charging and lowering mean power consumption.

Optionally, the proximity detector 124 performs a transmit signal analysis, for instance measures and analyses characteristics of the ongoing transmitter signal itself, such as amplitude, phase or frequency profiles. When a signal pattern matching known transmitter characteristics is detected, the receiver switches to active oscillations. Voltage, current, and/or power induced in the receiver coil can reliably indicate proximity of the transmitting coil's oscillating magnetic field. The decay frequency circuit may implement detection thresholds calibrated to typical ranges expected at junction distances. Sudden spikes above these levels indicate the transmitter signal is within the relevant wireless charging distances, triggering activation of the receiver to enhance the mutual detection process.

When proximity detector 124 determines transmitter signals are nearby, such as by detected field strength or specific signal markers, it activates the decay frequency circuit 122 to generate a signal matched to the sensed transmitter signal frequency. This signal may be amplified by amplifier to drive receiver coil 118. Oscillating receiving coil 118 while the transmitting coil 106 signal decays, when proximity is detected, creates detectable influences on the decay rate and patterns as measured by sensing circuit 112. However, when the receiver activates the decay frequency circuit 122 upon detecting the transmitter signals, the receiving coil 118 starts resonating. Due to magnetic coupling between transmitting 106 and receiving 118 coils, this receiving oscillation perturbs the natural exponential decay of currents in the isolated transmitting coil, altering the rate and shape of decay, for example slowing down the decay pace. For instance, the signal decays slower, namely loses the notability thereof by the transmitter sensing circuit 112 in a slower pace. This allows the transmitter sensing circuit 112 to detect indicators of the receiver influence analysing properties of the perturbed decay shape such as initial drop rate, concavity, zero-crossing points, mid-point slope, higher-frequency ripples introduced, and/or total settled amplitude after a set time.

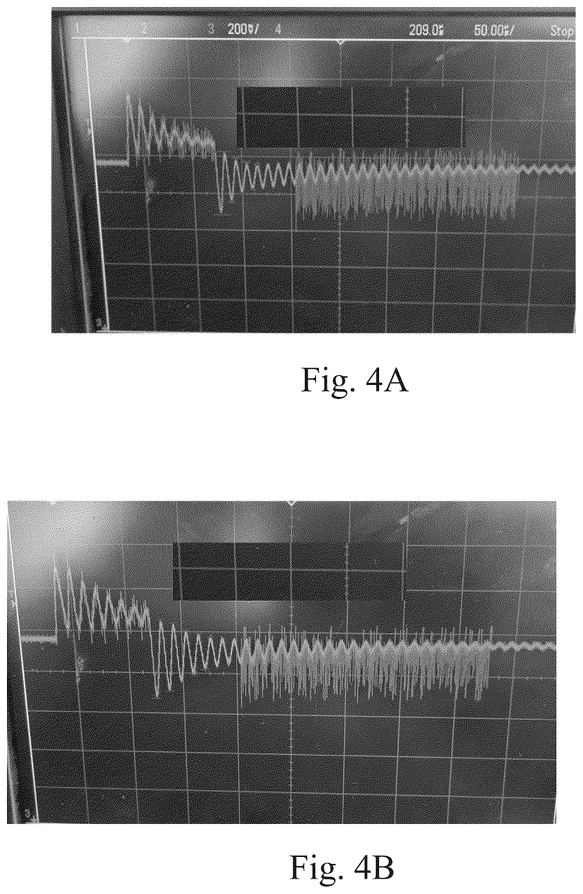

For example, while FIG. 4A images decay characteristics of a signal, referred to also as a Tx Analog ping signal, read by the rectification/regulation circuit 120 when the decay frequency circuit 122 is not activated and FIG. 4B images decay characteristics of a signal when it is read by the rectification/regulation circuit 120 when the decay frequency circuit 122 is activated. As shown by these figures, the Peak-to-peak (pk-pk), namely the difference between the highest and the lowest values in a waveform of the signal, is bigger when the decay frequency circuit 122 is activated. For clarity, the peak-to-peak value is twice the peak value or 2.828 times the root-mean-square (RMS) value.

Optionally, the wireless power transmitting unit (TX) utilizes information encoded in altered current decay patterns caused by the active receiving unit (RX) to dynamically adjust its power transfer properties. For example, the TX control circuitry may characterizes the natural exponential decay shape when no RX is present. This will follow a predictable curve over time. Then, when an RX is detected through the altered decay patterns, certain metrics like rate of drop, settled level, ripples indicate the degree of loading influence imparted by the power drawn/dissipated from magnetic coupling with the RX coil. Based on the loading depth and variation, the TX optionally dynamically tune operating parameters, including:
1. Transmission Power Level: If decay rate is too sharp, signifies underpowered so TX can increase oscillator drive strength and boost output field intensity to compensate.
2. Transmission Frequency: Small phase shifts or distorted periods in the decay shape can prompt TX to adjust the oscillator frequency to better match the RX resonant peak for optimized power transfer.

In this manner, the TX may perceive loading conditions and requirements of the wirelessly coupled RX using transmit coil current metrics proxying the coupling dynamics. This allows adaptive tuning of the wireless power transmission to match optimal properties for delivering power efficiently to the receivers detected.

Optionally, in 212, the decay frequency circuit 122 generates a signal matched to the sensed transmitter signal frequency by sequentially stepping through a range of frequencies until the oscillator frequency aligns with the transmitter signal frequency that is detected by the receiver coil. This swept frequency alignment allows matching even if the transmitter frequency is not known a priori. Alternatively, the oscillator frequency is adjusted based on phase alignment to the detected incoming signal from the transmitter. This dynamically or based on a preset matches and tracks any drift in the transmitter oscillator signal. Alternatively, components within the variable oscillator like varactors and tuning capacitors are dynamically adjusted to change the resonance of the tank circuit and local feedback loops to match the incoming signal frequency. Control logic sweeps the adaptable components seeking a frequency lock. Alternatively, the receiver may be able to directly measure properties of the transmitter signal to deduce carrier parameters like frequency, modulation type, coding scheme, etc. based on wireless charging standards. This information then configures the variable oscillator directly to the measured frequency.

The components, adjustment mechanisms, frequency locking details and control logic can vary in the implementations. But the key principle is that a variable, adaptive oscillator is used to actively match the transmitter frequency instead of having a fixed receiver frequency. This enables reliable operation even across transmitters with loosening component tolerances over time.

The decay characteristic changes are detected and analysed by control circuit 114 to determine RX presence with much higher reliability than in prior static receiver systems.

Optionally, based on valid decay pattern signatures exhibited when the power receiving unit 104 is present, the sensing data triggers logic checks, threshold detections, and pattern matching criteria set in the transmitter control circuit 114 to positively identify the power receiving unit 104 is nearby. The characteristics of decay due to a proximate resonant coil are distinct from alternative interference sources.

Optionally, the detection is based on resonance perturbation which provides clearly detectable changes in the slope, concavity, ripples, and asymptotes as the transmitter current decays. By analyzing not just threshold crossover points but full curve metrics, the amplified data provides earlier and more reliable detection indicators that the receiver is present. The expanded decay signal analysis also enables calibration of power transfer activation based on very small receiver devices.

Optionally, pattern recognition analysis is used to detect consistent and repeatable patterns exhibited in decay shape when the receiver is actively resonance. Optionally, a neural net model is used for the pattern recognition. In addition to rule-based algorithms, the system can implement various machine learning techniques to establish, refine and optimize reliable detection capabilities across wide variability in receiver configurations. This provides robust and resilient wireless power transfer activation decisions.

By using the power transfer system 100 to charge any wirelessly rechargeable device, such as a robot, an IoT device or a sensor, improved spatial freedom is achieved. The active RX oscillation enables reliable TX detection over wider lateral and vertical offset distances between coils. This allows more flexible positioning instead of precise placement. Moreover, interference issues are reduced as distinct RX perturbation patterns minimize false positives from environmental noise or unrelated fields. The receiver's influence carries a signature detected. Another benefit are size agility receivers that greatly improves detection sensitivity allowing small compact receiver units with miniature coils unlike passive systems. Enables integration into tiny IoT devices.

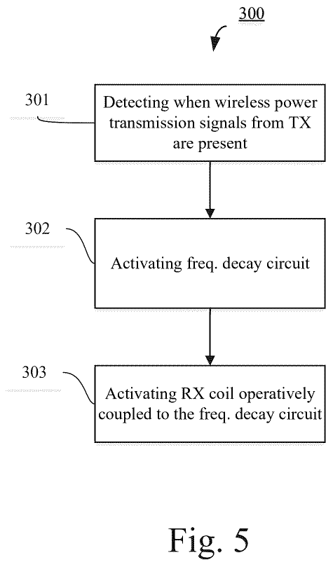

Reference is now also made to FIG. 5 which is a schematic illustration of a method of enabling enhanced detection in a wireless power receiving unit (RX) containing an RX coil, according to some embodiments of the present invention. First, as shown at 301, a proximity detector circuit, such as 124, is used for detecting when wireless power transmission signals from a power transmitting unit (TX), such as 102, are present in proximity of a RX coil, such as 118. Then, as shown at 302, in response to the detection of proximate TX signals, an oscillation circuit operatively coupled to the RX coil, such as decay frequency circuit 122, is activated. As shown at 303, the RX coil 118 is actively oscillated the utilizing the activated oscillation circuit, at a frequency matched to a frequency of a TX coil in the transmitting unit. As described above, actively oscillating the RX coil is timed to influence decay characteristics of a current in the TX coil enables more reliable detection by the TX that the RX is present near a wireless charging station due to distinct patterns caused in the TX coil current decay shape.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A wireless power transfer system for wirelessly charging a poll associated platform, comprising:
a wireless charging station comprising: a power transmitting unit (TX) configured to transmit wireless power by oscillating a TX coil current and detecting a power receiving unit (RX) by analyzing decay characteristics of the TX coil current;
wherein the poll associated platform having a water sealed compartment comprising a battery electrically connected to a power receiving unit (RX) comprising an RX coil;
wherein the power receiving unit (RX) further comprises a decay frequency circuit operatively coupled to the RX coil, said decay frequency circuit is configured to:
(a) detect when the power transmitting unit (TX) transmits wireless power in proximity to the power receiving unit (RX),
(b) actively oscillate the RX coil at a frequency matching the TX coil frequency, in response to said detection,
thereby influencing the decay characteristics of the TX coil current to enable more reliable detection by the power transmitting unit (TX) that the RX unit is present on or near the wireless charging station.

2. The wireless power transfer system according to claim 1, further comprising a proximity detector circuit to detect when the power transmitting unit (TX) transmits wireless power in proximity by detecting a marker signal transmitted by the TX.

3. The wireless power transfer system according to claim 1, further comprising a proximity detector to detect when the power transmitting unit (TX) transmits wireless power in proximity by detecting an increase in voltage, current, or power induced in the RX coil.

4. The wireless power transfer system according to claim 1, wherein the decay frequency matching between the TX coil and RX coil is achieved by making active decay to the RX coil.

5. The wireless power transfer system according to claim 1, wherein the frequency matching between the TX coil and RX coil is achieved by tuning the variable oscillator frequency in the active oscillation circuitry to match the sensed TX coil decay frequency.

6. The wireless power transfer system according to claim 1, wherein influencing the decay characteristics of the TX coil current enables detection by amplitude drop thresholds over time.

7. The wireless power transfer system according to claim 1, wherein influencing the decay characteristics of the TX coil current enables more consistent decay signature profiles analyzed by the power transmitting unit to detect the presence of the RX coil in proximity.

8. A method for wireless power transfer to a poll associated platform comprising:
within a power transmitting unit (TX) of the poll associated platform charging station:
(a) transmitting wireless power by oscillating a current in a TX coil;
(b) detecting presence of a power receiving unit (RX) by analyzing decay characteristics of the TX coil current when oscillation is paused;
within a power receiving unit (RX) containing an RX coil in a water sealed compartment of the poll associated platform:
(c) detecting when wireless power signals are transmitted in proximity of the RX unit;
(d) actively oscillating the RX coil at a decay frequency in response to detection of the proximate wireless power signals;
whereby actively oscillating the RX coil influences the decay characteristics of the TX coil current, enabling more reliable detection by the TX unit that the RX unit is present near a wireless charging station based on the altered decay characteristics.

9. A method for enabling enhanced detection in a wireless power receiving unit (RX) containing an RX coil, the method comprising:
(a) at a wireless charging station, detecting, by a proximity detector circuit, when wireless power transmission signals from a power transmitting unit (TX) of the wireless charging station are present in proximity of the RX coil;
(b) in a water sealed compartment of a poll associated platform, in response to said detection of proximate TX signals, activating an oscillation circuit operatively coupled to the RX coil in the water sealed compartment;
(c) actively oscillating the RX coil utilizing the activated oscillation circuit, at a frequency matched to a frequency of a TX coil in the transmitting unit;
wherein actively oscillating the RX coil is timed to influence decay characteristics of a current in the TX coil, thereby enabling more reliable detection by the TX that the RX is present near the wireless charging station due to distinct patterns caused in the TX coil current decay shape.

10. The method of claim 9, wherein the RX coil is located within a distance of less than 10 millimeter from the TX coil.

11. The method of claim 9, wherein the frequency matching between the TX coil and the RX coil is achieved by tuning an RX oscillation circuit capacitance to make the RX coil resonant at the same frequency as the TX coil frequency.

12. The method of claim 9, wherein actively oscillating the RX coil utilizes a frequency decay circuit in order to tune an oscillation frequency generated in the RX to match a frequency of detected TX wireless power transmission signals.

13. The method of claim 9, wherein influencing decay characteristics of the TX coil current enables detection by amplitude drop thresholds over time in the TX circuit.

14. The method of claim 9, wherein influencing decay characteristics of the TX coil current induces repeatable perturbation patterns that are analyzed in the TX to reliably detect presence of the RX.

15. A wireless power receiving apparatus comprising:
an RX coil configured to receive wireless power signals;
a proximity detector circuit operatively connected to the RX coil configured to detect when wireless power transmission signals from a power transmitting unit (TX) are present in proximity of the RX coil;
a frequency decay circuit operatively connected to RX coil, said frequency decay circuit configured to: (a) activate in response to detection of proximate TX signals by the proximity detector circuit, (b) actively oscillate the RX coil at a frequency matched to a TX coil frequency in the TX;
wherein activation and active oscillation of the frequency decay circuit is configured to influence decay characteristics of a TX coil current in the TX, thereby enabling more reliable detection by the TX that the wireless power receiving apparatus is present near a wireless charging station due to distinct patterns caused in the TX coil current decay shape.
